(19) United States
(12) Patent Application Publication
(10) Pub. No.: US 2021/0165387 A1
(43) Pub. Date: Jun. 3, 2021

(54) GIMBAL CONTROL METHOD, GIMBAL AND GIMBAL CONTROL SYSTEM

(71) Applicant: SZ DJI TECHNOLOGY CO., LTD., Shenzhen (CN)

(72) Inventors: Shuai LIU, Shenzhen (CN); Liyuan LIU, Shenzhen (CN); Bing LI, Shenzhen (CN)

(21) Appl. No.: 17/173,164

(22) Filed: Feb. 10, 2021

Related U.S. Application Data
(63) Continuation of application No. PCT/CN2018/102007, filed on Aug. 23, 2018.

(51) Int. Cl. G05B 19/19; F16M 11/18; G05D 3/20; F16M 11/12; G05D 1/00

(52) U.S. Cl. CPC G05B 19/19; F16M 11/18; G05D 1/0016; F16M 11/123; G05D 3/20

(57) ABSTRACT

A gimbal control method includes obtaining a speed of a mouse; and controlling an attitude of a gimbal according to the speed of the mouse.

### CROSS-REFERENCE TO RELATED APPLICATION

This application is a continuation of International Application No. PCT/CN2018/102007, filed on Aug. 23, 2018, the entire content of which is incorporated herein by reference.

### TECHNICAL FIELD

The present disclosure relates to the technical field of gimbal and, more particularly, to a gimbal control method, a gimbal, and a gimbal control system.

### BACKGROUND

Currently, an attitude of a gimbal is often controlled by a remote controller or a terminal device with a control APP installed thereon. Operation of the remote controller is often constrained by potential factors such as joystick rebound and joystick being stuck at a mechanical limit. Moreover, most remote controllers need to be adapted to or matched with a corresponding unmanned aerial vehicle (UAV), unmanned automobile, or receiver. The terminal device, such as a mobile phone, has a sampling frequency of touch-control operation limited by a refreshing frequency of a touch-control screen (usually 60 Hz). Sensitivity of the touch-control screen cannot satisfy rapid operation and accurate response requirements of competitive gaming. Further, resolution of mobile phone touch-control operation is limited and not conducive to accurate operation and precise strike by advanced players.

### SUMMARY

In accordance with the disclosure, there is provided a gimbal control method. The method includes obtaining a speed of a mouse; and controlling an attitude of a gimbal according to the speed of the mouse.

Also in accordance with the disclosure, there is provided a gimbal. The gimbal includes an electric motor; an electronic speed control (ESC) electrically connected to the electric motor; and a processor electrically connected to the ESC and configured to be communicatively connected to a mouse. The processor is configured to obtain a speed of the mouse and control an attitude of the gimbal according to the speed of the mouse.

Also in accordance with the disclosure, there is provided a gimbal control system. The gimbal control system includes a mouse assembly including a mouse and a gimbal including an electric motor, an electronic speed control (ESC) electrically connected to the electric motor, and a processor electrically connected to the ESC and communicatively connected to the mouse. The processor is configured to obtain a speed of the mouse and control an attitude of the gimbal according to the speed of the mouse.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts and may be encompassed in the present disclosure.

FIG. 1 is a flowchart of a gimbal control method according to an example embodiment of the present disclosure.

FIG. 2 is a schematic structural diagram of a gimbal control system according to an example embodiment of the present disclosure.

FIG. 3 is a schematic structural diagram of a gimbal control system according to another example embodiment of the present disclosure.

FIG. 4 is a schematic structural diagram of a gimbal control system according to another example embodiment of the present disclosure.

FIG. 5 is a flowchart of a gimbal control method according to another example embodiment of the present disclosure.

FIG. 6 is a schematic diagram showing decomposition of a speed of a mouse according to an example embodiment of the present disclosure.

FIG. 7 is a flowchart of a gimbal control method according to another example embodiment of the present disclosure.

FIG. 8 is a schematic structural diagram of a gimbal control system according to another example embodiment of the present disclosure.

FIG. 9 is a schematic structural diagram of a gimbal control system according to another example embodiment of the present disclosure.

### REFERENCE NUMERALS

100: gimbal
110: processor
120: electric motor
130: wireless receiver
200: mouse assembly
210: mouse
220: wireless remote controller
230: wireless transmitter

### DETAILED DESCRIPTION OF THE EMBODIMENTS

Embodiments of the present disclosure are described in detail below with reference to the accompanying drawings. It will be appreciated that the described embodiments are some rather than all of the embodiments of the present disclosure. Other embodiments obtained by those having ordinary skills in the art on the basis of the described embodiments without inventive efforts should fall within the scope of the present disclosure.

The gimbal control method, the gimbal, and the gimbal control system consistent with the embodiments of the present disclosure will be described in detail with reference to the accompanying drawings. Under circumstances of no conflict, the embodiments and the features in the embodiments may be combined with each other.

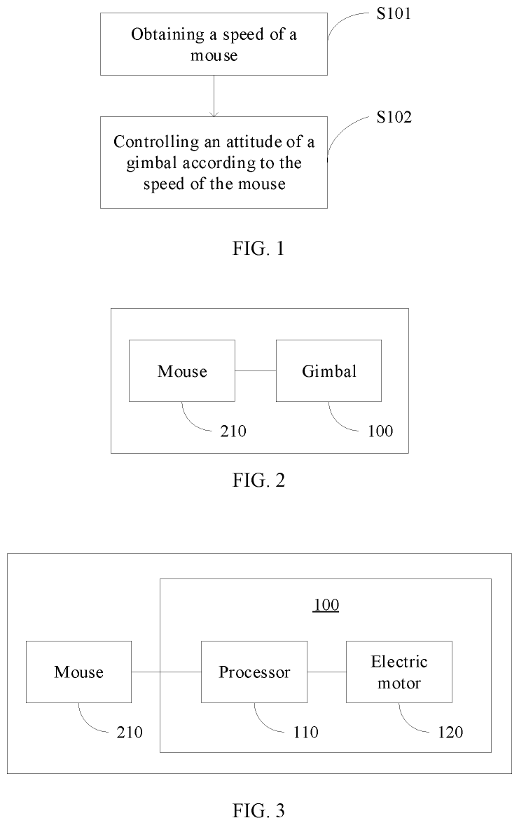

FIG. 1 is a flowchart of a gimbal control method according to an example embodiment of the present disclosure. The method may be executed by a gimbal 100 such as a gimbal controller or an independent controller provided at the gimbal 100. As shown in FIG. 1, the gimbal control method includes the following processes.

At S101, a speed of a mouse 210 is obtained.

FIG. 2 is a schematic structural diagram of a gimbal control system according to an example embodiment of the present disclosure. As shown in FIG. 2, in some embodiments, the mouse 210 and the gimbal 200 are communicatively connected. FIG. 3 is a schematic structural diagram of a gimbal control system according to another example embodiment of the present disclosure. As shown in FIG. 3, the gimbal 100 includes a processor 110 and an electric motor 120 electrically connected to the processor 110. The mouse 210 and the processor 110 are communicatively connected. The mouse 210 and the processor 110 may be connected through wired communication or wireless communication.

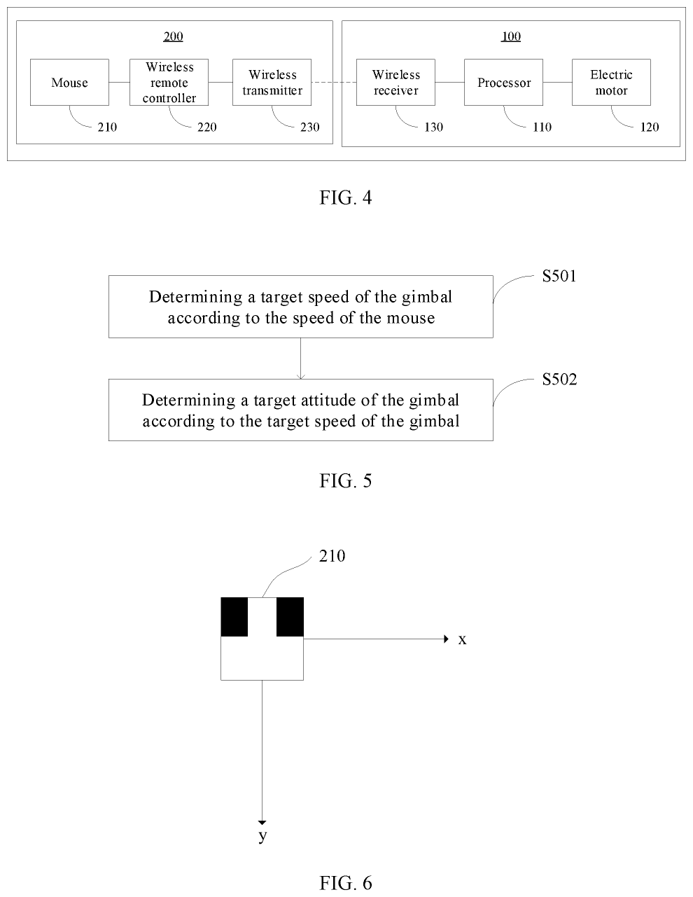

In some embodiments, the mouse 210 and the processor 110 are connected through wireless communication. FIG. 4 is a schematic structural diagram of a gimbal control system according to another example embodiment of the present disclosure. As shown in FIG. 4, the gimbal 100 further includes a wireless receiver 130. The wireless receiver 130 is electrically connected to the processor 110. The wireless receiver 130 is configured to be wirelessly connected to the mouse 210. Further, the mouse 210 is connected to a wireless remote controller 220, which is in turn connected to a wireless transmitter 230. The wireless transmitter 230 communicates with the wireless receiver 130, thereby achieving a wireless connection between the mouse 210 and the processor 110. The wireless connection between the mouse 210 and the processor 110 may be a Wi-Fi connection, a Bluetooth connection, or a 5G mobile connection.

In some embodiments, the gimbal 100 may be a handheld gimbal or a gimbal mounted at an unmanned aerial vehicle (UAV) or a remotely controlled automobile.

In addition, the gimbal 100 may be a two-axis gimbal or a three-axis gimbal. For illustration purpose, the three-axis gimbal will be described in the following embodiments. For the three-axis gimbal, the electric motor 120 includes a yaw-axis electric motor, a pitch-axis electric motor, and a roll-axis electric motor for controlling a yaw angle, a pitch angle, and a roll angle, respectively.

At S102, an attitude of the gimbal 100 is controlled according to the speed of the mouse 210.

FIG. 5 is a flowchart of a gimbal control method according to another example embodiment of the present disclosure. As shown in FIG. 5, S102 includes the following processes.

At S501, a target speed of the gimbal 100 is determined according to the speed of the mouse 210.

In some embodiments, at S501, the speed of the mouse 210 is converted to the target speed of the gimbal 100 according to a pre-configured strategy. The pre-configured strategy for converting the speed of the mouse 210 to the target speed of the gimbal 100 may be a linear mapping, a curved mapping, or a look-up table for determining the target speed of the gimbal 100 corresponding to the current speed of the mouse 210. The pre-configured strategy may be determined to be any one of the above methods as needed.

In some embodiments, the speed of the mouse 210 is converted to the target speed of the gimbal 100 according to a pre-configured linear mapping relationship between the speed of the mouse 210 and the target speed of the gimbal 100.

In some other embodiments, the speed of the mouse 210 is converted to the target speed of the gimbal 100 according to a pre-configured curved mapping relationship between the speed of the mouse 210 and the target speed of the gimbal 100.

The obtained target speed can be a Euler speed.

Further, at S501, a speed of the yaw-axis electric motor and a speed of the pitch-axis electric motor are determined according to the speed of the mouse 210. In some embodiments, the speed of the mouse 210 is decomposed to obtain a speed of the mouse 210 in a first direction (x-axis in FIG. 6) and a speed of the mouse 210 in a second direction (y-axis in FIG. 6). The speed of the yaw-axis electric motor is determined according to the speed of the mouse 210 in the first direction and the speed of the pitch-axis electric motor is determined according to the speed of the mouse 210 in the second direction. The first direction and the second direction intersect with each other. In some embodiments, the speed of the yaw-axis electric motor is the speed in the first direction and the speed of the pitch-axis electric motor is the speed in the second direction. FIG. 6 is a schematic diagram showing decomposition of a speed of the mouse 210 according to an example embodiment of the present disclosure. In the example shown in FIG. 6, the first direction is the x-axis and the second direction is the y-axis. The x-axis and the y-axis are perpendicular to each other and the x-axis is a horizontal axis.

In some embodiments, the speed of the mouse 210 is decomposed to obtain the speed of the yaw-axis electric motor and the speed of the pitch-axis electric motor. A target attitude (the yaw angle and the pitch angle) of the gimbal 100 is determined according to the speed of the yaw-axis electric motor and the speed of the pitch-axis electric motor, thereby achieving the control of the yaw angle (i.e., a yaw-axis attitude) and the pitch angle (i.e., a pitch-axis attitude) of the gimbal 100.

Further, to prevent erroneous control of the attitude of the gimbal 100 caused by an accidental bump of the mouse 210, the method consistent with the present disclosure needs to perform a dead-zone processing on the speed of the mouse 210 in the first direction before the speed of the yaw-axis electric motor is determined according to the speed of the mouse 210 in the first direction. The speed of the mouse 210 in the first direction is optimized to more accurately control the yaw angle of the gimbal 100. Specifically, before the speed of the yaw-axis electric motor is determined according to the speed of the mouse 210 in the first direction, whether the speed of the mouse 210 in the first direction is greater than or equal to a first speed threshold is determined. Moreover, the dead-zone processing needs to be performed on the speed of the mouse 210 in the second direction before the speed of the pitch-axis electric motor is determined according to the speed of the mouse 210 in the second direction. The speed of the mouse 210 in the second direction is optimized to more accurately control the pitch angle of the gimbal 100. Specifically, before the speed of the yaw-axis electric motor is determined according to the speed of the mouse 210 in the second direction, whether the speed of the mouse 210 in the second direction is greater than or equal to a second speed threshold is determined. In some embodiments, values of the first speed threshold and the second speed threshold may be determined according to the actual control accuracy requirement. In addition, the first speed threshold and the second speed threshold may be equal to or different from each other. The first speed threshold and the second speed threshold may be configured according to the actual control requirement.

As a gimbal control method for reality games, an input of the mouse 210 is directly used to control the attitude of the gimbal 100. The optimized method based on the input of the mouse 210 is as good as gaming experiences of popular virtual shooting games (e.g., CS, tank world). Compared with the touch-control of the terminal device with APP installed thereon and a joystick control of the remote controller, the method of controlling the attitude of the gimbal 100 through the mouse 210 is more flexible, more fluent, more accurate, thereby satisfying the needs of competitive games.

In some embodiments, the movement of the mouse 210 may also be used to control the roll angle (i.e., the roll-axis attitude) of the gimbal 100. Specifically, before the speed of the mouse 210 is obtained, the mouse 210 switches from controlling the yaw angle and the pitch angle of the gimbal 100 to controlling the roll angle of the gimbal 100 when receiving a first switching signal. After the first switching signal is received and the speed of the mouse 210 is obtained, the speed of the roll-axis electric motor is determined according to the speed of the mouse 210. After the speed of the roll-axis electric motor is obtained, the target attitude (i.e., the roll angle) of the gimbal 100 is determined according to the speed of the roll-axis electric motor.

In some embodiments, the speed of the roll-axis electric motor may be configured to be the speed of the mouse 210 in the first direction, the speed of the mouse 210 in the second direction, or the speed of the mouse 210 (i.e., the combined speed of the speed in the first direction and the speed in the second direction). Further, to prevent erroneous control of the attitude of the gimbal 100 caused by the accidental bump of the mouse 210, the method consistent with the present disclosure needs to perform the dead-zone processing on the speed of the mouse 210 before the speed of the roll-axis electric motor is determined according to the speed of the mouse 210. The speed of the mouse 210 is optimized to more accurately control the roll angle of the gimbal 100. Specifically, before the speed of the roll-axis electric motor is determined according to the speed of the mouse 210, whether the speed of the mouse 210 is greater than or equal to a third speed threshold is determined. In some embodiments, values of the third speed threshold may be determined according to the actual control accuracy requirement.

Further, after the first switching signal is received, the mouse 210 switches from controlling the yaw angle and the pitch angle of the gimbal 100 to controlling the roll angle of the gimbal 100 when receiving a second switching signal. Specifically, after the second switching signal is received and the speed of the mouse 210 is obtained, the speed of the yaw-axis electric motor and the speed of the pitch-axis electric motor are determined according to the speed of the mouse 210. The method of determining the speed of the yaw-axis electric motor and the speed of the pitch-axis electric motor according to the speed of the mouse 210 can be referred to the description of the previous embodiments, which will not be repeated herein.

In some embodiments, the first switching signal and the second switching signal may be generated when a left-button and a right-button, respectively, of the mouse 210 are triggered, or both may be generated when either the left-button or the right-button of the mouse 210 is triggered. When first switching signal and the second switching signal are generated when either the left-button or the right-button of the mouse 210 is triggered, a number of clicks or a clicking frequency of either the left-button or the right-button of the mouse 210 is used to determine whether the first switching signal or the second switching signal needs to be generated. In one example, the first switching signal is generated when the right-button of the mouse 210 is triggered and the second switching signal is generated when the left-button of the mouse 210 is triggered. In another example, the first switching signal is generated when the left-button of the mouse 210 is triggered and the second switching signal is generated when the right-button of the mouse 210 is triggered. In another example, the first switching signal is generated when the left-button of the mouse 210 is clicked twice and a time interval between the two clicks is less than 2 seconds, and the second switching signal is generated when the left-button of the mouse 210 is clicked three times and the time interval between adjacent clicks is less than 2 seconds.

At S502, the target attitude of the gimbal 100 is determined according to the target speed of the gimbal 100.

The target speed obtained at S502 is the Euler speed, which needs to be converted to obtain the target attitude of the gimbal 100. In some embodiments, the target speed is subject to integration processing to obtain the target attitude of the gimbal 100, such that the attitude of the gimbal 100 is controlled according to the target attitude. Specifically, the gimbal 100 is controlled to move toward the target attitude according to the target attitude of the gimbal 100. The gimbal 100 consistent with the present disclosure also includes an electronic speed control (ESC) electrically connected to the electric motor 120. A driving signal for driving the electric motor 120 is generated according to the target attitude of the gimbal 100. Then, driving signal is sent to the ESC to control the electric motor 120 to rotate. In some embodiments, the greater the target attitude, the stronger an amplitude of the driving signal (i.e., an output torque of the electric motor 120), and the greater a rotation angle of the electric motor 120.

After at least one of the speed of the yaw-axis electric motor, the speed of the pitch-axis electric motor, or the speed of the roll-axis electric motor of the gimbal 100 is determined at S502, at least one of the target attitude of the yaw-axis electric motor, the target attitude of the pitch-axis electric motor, or the target attitude of the roll-axis electric motor is determined correspondingly. At least one of the attitude of the yaw-axis electric motor, the attitude of the pitch-axis electric motor, or the attitude of the roll-axis electric motor is determined correspondingly according to at least one of the target attitude of the yaw-axis electric motor, the target attitude of the pitch-axis electric motor, or the target attitude of the roll-axis electric motor, thereby achieving the control of the attitude of the gimbal 100.

In addition, when multiple input devices simultaneously request to control the attitude of the gimbal 100, one of the multiple input devices needs to be determined to control the gimbal 100 to rotate. In some embodiments, before S101, it is needed to determine that the mouse 210 is the control device for controlling the gimbal 100 to rotate. One of the multiple input devices is determined to control the gimbal 100 to rotate according to a control priority level of each of the multiple input device. In some embodiments, when the multiple input devices are connected to the gimbal 100, the mouse 210 has the highest control priority level among the multiple input devices, and the mouse 210 is determined to control the gimbal 100 to rotate. In some other embodiments, one of the multiple input devices is determined to control the gimbal 100 to rotate according to a time sequence of each of the multiple input device requesting for controlling the attitude of the gimbal 100. For example, the input device requesting for controlling the attitude of the gimbal 100 at earliest time is determined to control the gimbal 100 to rotate.

In some embodiments, after the mouse 210 is determined to control the gimbal 100 to rotate, a new input device is detected to be connected to the gimbal 100. When the new input device has a control priority level higher than the control priority level of the mouse 210, control of the rotation of the gimbal 100 is switched from the mouse 210 to the new input device, thereby achieving the switching of the control of the gimbal 100 and satisfying user's need.

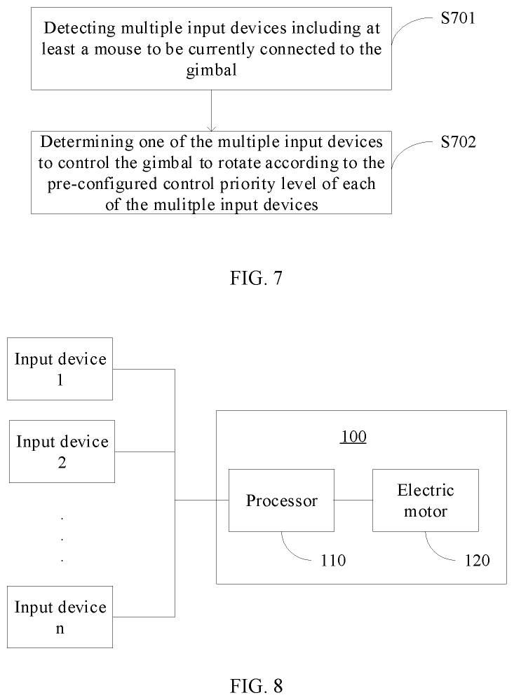

FIG. 7 is a flowchart of a gimbal control method according to another example embodiment of the present disclosure. As shown in FIG. 7, the gimbal control method further includes the following processes.

At S601, multiple input devices are detected to be connected to the gimbal 100. For example, as shown in FIG. 8, the input devices include input device 1, input device 2, . . . , input device n, where n is a positive integer. The multiple input devices at least include the mouse 210.

S610 may be performed before or after S101. When S610 is performed before S101, S101 is performed only when the mouse 210 is determined to control the gimbal 100 to rotate.

All input devices are external devices to the gimbal 100. The multiple input devices are connected to the gimbal controller through different protocols, such that different input devices can be distinguished.

In some embodiments, the input devices also include a remote controller, a terminal device (e.g., a mobile phone, a tablet computer, a smart watch, etc.) with a control APP installed thereon, or another device capable of controlling the attitude of the gimbal 100. In some embodiments, the input devices include the mouse 210, the remote controller, and the terminal device with the control APP installed thereon.

Further, in some embodiments, the gimbal 100 creates a data storage table to record a device ID of each input device, an online connection status, and an online waiting time. When the new input device is detected to be connected to the gimbal 100, the data storage table is updated accordingly. For each input device, the gimbal 100 provides a counter and a time monitoring circuit accordingly. The time monitoring circuit monitors a time that the corresponding input device has been connected to the gimbal 100. When the time that the input device has been connected to the gimbal 100 is greater than or equal to a pre-configured time threshold (e.g., 10 seconds), the counter corresponding to the input device is updated to a connected state. When the input device that has been connected to the gimbal 100 for the time smaller than the pre-configured time threshold is disconnected or timed out, the counter corresponding to the input device is not updated.

In some embodiments, before the input device is determined to be connected to the gimbal 100, the state of the counter corresponding to the input device is verified. After the counter corresponding to the input device is verified to be updated to the connected state, the input device is determined to be connected to the gimbal 100.

At S602, one of the multiple input devices is determined to control the gimbal 100 to rotate according to pre-configured control priority levels.

In some embodiments, whether an input device is connected to the gimbal 100 is automatically determined by software. When the multiple input devices are detected to be connected to the gimbal 100, the control priority level of each input device is used to determine which input device controls the gimbal 100 to rotate, thereby achieving a secured control of the gimbal 100 and satisfying user's control need.

One of the multiple input devices having the highest control priority level is determined according to the pre-configured control priority level of each of the multiple input devices to control the gimbal 100 to rotate at S602. The gimbal 100 is controlled by the input device having the highest control priority level, thereby ensuring the secured control of the gimbal 100.

In some embodiments, the multiple input devices include the mouse 210, the remote controller, and the terminal device with the control APP installed thereon. The control priority levels of these input devices in a descending order are the remote controller, the mouse 210, and the terminal device with the control APP installed thereon. The terminal device is used to receive a touch command and a somatosensory command inputted by a user. The touch command has the control priority level higher than the somatosensory command.

FIG. 8 is a schematic structural diagram of a gimbal control system according to another example embodiment of the present disclosure. In some embodiments, as shown in FIG. 8, the gimbal 100 includes a processor 110 and an electric motor 120. In some embodiments, the gimbal 100 further includes an ESC. The processor 110 and the ESC are electrically connected to each other and are both communicatively connected to a mouse 210. The ESC and the electric motor 120 are electrically connected.

In some embodiments, the processor 110 is a central processing unit (CPU). The processor 110 further includes a hardware chip. The hardware chip may be an application-specific integrated circuit (ASIC), a programmable logic device (PLD), or a combination thereof. The PLD may be a complex programmable logic device (CPLD), a field-programmable gate array (FPGA), a generic array logic (GAL), or any combination thereof.

The processor 110 can be configured to implement the example methods shown in FIG. 1, FIG. 5, and FIG. 7. In some embodiments, the processor 110 is configured to obtain a speed of the mouse 210, and control an attitude of the gimbal 100 according to the speed of the mouse 210.

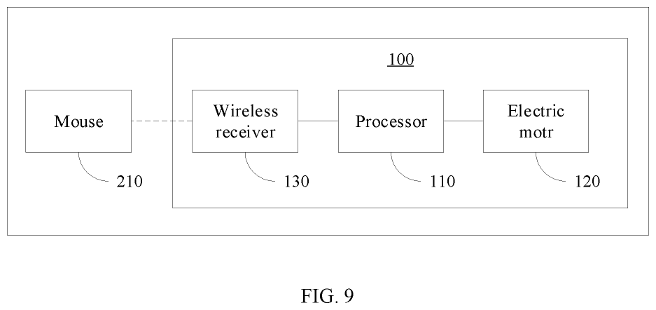

The processor 110 and the mouse 210 may be connected by a wired connection or a wireless connection. FIG. 9 is a schematic structural diagram of a gimbal control system according to another example embodiment of the present disclosure. In some embodiments, as shown in FIG. 9, the gimbal 100 further includes a wireless receiver 130 electrically connected to the processor 110. The wireless receiver 130 is configured to wirelessly communicate with the mouse 210. In some embodiments, the wireless receiver 130 and the mouse 210 are wirelessly connected through a Wi-Fi connection, a Bluetooth connection, or a 5G mobile connection.

The gimbal 100 further includes a storage device. The storage device includes a volatile memory such as a random-access memory (RAM), a non-volatile memory such as a flash memory, a hard disk drive (HDD), or a solid-state drive (SSD), or a combination thereof. In some embodiments, the storage device is configured to store program instructions. The processor 110 may invoke the program instructions to implement the gimbal control method in the above-described embodiments.

As shown in FIGS. 2-4 and FIG. 8, the present disclosure also provides a gimbal control system. The gimbal control system includes a gimbal 100 and a mouse assembly 200. The gimbal 100 includes a processor 110, an ESC, and an electric motor 120. The mouse assembly 200 includes a mouse 210. The processor 110 and the ESC are electrically connected to each other and are both communicatively connected to the mouse 210. The ESC and the electric motor 120 are electrically connected.

In some embodiments, the processor 110 is a central processing unit (CPU). The processor 110 further includes a hardware chip. The hardware chip may be an application-specific integrated circuit (ASIC), a programmable logic device (PLD), or a combination thereof. The PLD may be a complex programmable logic device (CPLD), a field-programmable gate array (FPGA), a generic array logic (GAL), or any combination thereof.

The processor 110 can be configured to implement the example methods shown in FIG. 1, FIG. 5, and FIG. 7. In some embodiments, the processor 110 is configured to obtain a speed of the mouse 210, and control an attitude of the gimbal 100 according to the speed of the mouse 210.

The processor 110 and the mouse 210 may be connected by a wired connection or a wireless connection. In some embodiments, as shown in FIG. 4, the gimbal 100 further includes a wireless receiver 130 electrically connected to the processor 110. The mouse assembly 200 further includes a wireless remote controller 220 and a wireless transmitter 230. The mouse 210 is electrically connected to the wireless transmitter 230 through the wireless remote controller 220. The wireless transmitter 230 and the wireless receiver 130 are wirelessly connected. In some embodiments, the wireless receiver 130 and the wireless transmitter 230 are wirelessly connected through a Wi-Fi connection, a Bluetooth connection, or a 5G mobile connection.

Further, the gimbal 100 further includes a storage device. The storage device includes a volatile memory such as a random-access memory (RAM), a non-volatile memory such as a flash memory, a hard disk drive (HDD), or a solid-state drive (SSD), or a combination thereof. In some embodiments, the storage device is configured to store program instructions. The processor 110 may invoke the program instructions to implement the gimbal control method in the above-described embodiments.

In the embodiments of the present disclosure, the movement of the mouse 210 directly controls the attitude of the gimbal 100, which is more in line with operating habits of first-person shooting game players, and the substantially high movement sensitivity and resolution of the mouse 210 facilitate rapid control, precise operation, and accurate response. As the gimbal control method for reality games, the movement of the mouse 210 is directly used to control the attitude of the gimbal 100. The method optimized based on the movement of the mouse 210 is as good as gaming experiences of popular virtual shooting games (e.g., CS, tank world). Compared with the touch-control of the terminal device with the APP installed thereon and the joystick control of the remote controller, the method of controlling the attitude of the gimbal 100 through the mouse 210 is more flexible, more fluent, more accurate, thereby satisfying the needs of competitive games. Moreover, the present disclosure supports adaptation of the mouse 210 with different performances to satisfy the gaming experience requirement of different players, and is not limited to the remote controller and the terminal device which adapt to a feel only by adjusting exp (a function trigger button for fine-tuning the control of the attitude of the gimbal 100 by the remote controller or the terminal device.)

Further, gimbal control method based on the mouse 210 provides an experience better than the remote controller operating experience of traditional UAVs and unmanned automobiles. Compared with the remote controller operation, the gimbal control method is not constrained by potential factors such as joystick rebound and joystick being stuck at a mechanical limit or the customization requirement for the remote controller to adapt to the UAVs and the unmanned automobiles. Any type of the mouses 210 (supporting generic protocol) may be used in the operation. Thus, the control of the attitude of the gimbal 100 is more convenient and friendly.

In addition, the response rate of the mouse 210 operation is often greater than 100 Hz (likely 500 to 1,000 Hz for a gaming mouse 210), which is substantially greater than the touch screen sampling rate of 60 Hz. Compared with the touch-control operation of the terminal device, the gimbal control method based on the mouse 210 is faster.

In addition, whether each input device is connected to the gimbal 100 is automatically determined by software. When the multiple input devices are detected to be connected to the gimbal 100, the control priority level of each input device is used to determine which input device controls the gimbal 100 to rotate, thereby achieving the secured control of the gimbal 100 and satisfying the user's control need.

FIG. 7 is a flowchart of a gimbal control method according to another example embodiment of the present disclosure. The method may be executed by the gimbal 100 such as a gimbal controller or an independent controller provided at the gimbal 100. As shown in FIG. 7, the gimbal control method includes the following processes.

At S701, multiple input devices including at least the mouse 210 are detected to be currently connected to the gimbal 100.

At S702, one of the multiple input devices is determined to control the gimbal 100 to rotate according to the pre-configured control priority level of each of the multiple input devices.

In some embodiments, whether each input device is connected to the gimbal 100 is automatically determined by software. When the multiple input devices are detected to be connected to the gimbal 100, the control priority level of each input device is used to determine which input device controls the gimbal 100 to rotate, thereby achieving the secured control of the gimbal 100 and satisfying the user's control need.

Further, after S702 is performed, when another input device is detected to be connected to the gimbal, the control priority level of the newly connected input device is compared with the control priority level of the device currently controlling the gimbal to rotate. When the control priority level of the newly connected input device is higher than the control priority level of the currently controlling device, controlling the gimbal to rotate is switched from the currently controlling device to the newly connected input device. When the control priority level of the newly connected input device is lower than the control priority level of the currently controlling device, the currently controlling device continues to control the gimbal to rotate.

The remaining part of the gimbal control method may be referred to the corresponding description of the embodiments in FIG. 7 and will not be repeated herein.

As shown in FIG. 8 and FIG. 9, the present disclosure also provides a gimbal 100. The gimbal 100 includes a processor 110 and an electric motor 120. The processor 110 and the electric motor 120 are communicatively connected to each other.

The processor 110 can implement the example method shown in FIG. 7. In some embodiments, the processor 110 is configured to detect multiple input devices including at least the mouse 210 to be currently connected to the gimbal 100 and determine one of the multiple input devices to control the gimbal 100 to rotate according to the pre-configured control priority level of each of the multiple input devices.

In addition, the present disclosure also provides a computer-readable storage medium for storing a computer program. When being executed by the processor 110, the computer program can implement the gimbal control methods in the above-described embodiments.

A person of ordinary skill in the art can understand that some or all of the processes in the above-described embodiments can be implemented by instructing relevant hardware through the computer program. The computer program may be stored in the computer-readable storage medium. When being executed, the computer program implements the processes in the above-described embodiments. The computer-readable storage medium may be a magnetic disk, an optical disk, a read-only memory (ROM), or a random-access memory (RAM), etc.

In the specification, specific examples are used to explain the principles and implementations of the present disclosure. The description of the embodiments is intended to assist comprehension of the methods and core inventive ideas of the present disclosure. At the same time, those of ordinary skill in the art may change or modify the specific implementation and the scope of the application according to the embodiments of the present disclosure. Thus, the content of the specification should not be construed as limiting the present disclosure.

What is claimed is:

1. A gimbal control method comprising:
obtaining a speed of a mouse; and
controlling an attitude of a gimbal according to the speed of the mouse.

2. The method according to claim 1, wherein controlling the attitude of the gimbal according to the speed of the mouse includes:
determining a target speed of the gimbal according to the speed of the mouse; and
determining a target attitude of the gimbal according to the target speed of the gimbal.

3. The method according to claim 2, wherein determining the target speed of the gimbal according to the speed of the mouse includes:
converting the speed of the mouse to the target speed of the gimbal according a pre-configured strategy.

4. The method according to claim 3, wherein converting the speed of the mouse to the target speed of the gimbal according the pre-configured strategy includes:
converting the speed of the mouse to the target speed of the gimbal according to a pre-configured linear mapping relationship or a pre-configured curved mapping relationship between the speed of the mouse and the target speed of the gimbal.

5. The method according to claim 2, wherein determining the target attitude of the gimbal according to the target speed of the gimbal includes:
performing integration processing on the target speed of the gimbal to obtain the target attitude of the gimbal.

6. The method according to claim 2, wherein:
the gimbal includes a yaw-axis electric motor and a pitch-axis electric motor; and
determining the target speed of the gimbal according to the speed of the mouse includes determining a speed of the yaw-axis electric motor and a speed of the pitch-axis electric motor according to the speed of the mouse.

7. The method according to claim 6, wherein determining the speed of the yaw-axis electric motor and the speed of the pitch-axis electric motor according to the speed of the mouse includes:
decomposing the speed of the mouse to obtain a speed of the mouse in a first direction and a speed of the mouse in a second direction, the first direction intersecting with the second direction;
determining the speed of the yaw-axis electric motor according to the speed of the mouse in the first direction; and
determining the speed of the pitch-axis electric motor according to the speed of the mouse in the second direction.

8. The method according to claim 7, further comprising, before determining the speed of the yaw-axis electric motor according to the speed of the mouse in the first direction:
determining that the speed of the mouse in the first direction is greater than or equal to a speed threshold.

9. The method according to claim 7, further comprising, before determining the speed of the pitch-axis electric motor according to the speed of the mouse in the second direction:
determining that the speed of the mouse in the second direction is greater than or equal to a speed threshold.

10. The method according to claim 6, further comprising, before obtaining the speed of the mouse:
receiving a switching signal;
wherein determining the target speed of the gimbal according to the speed of the mouse includes determining the speed of a roll-axis electric motor of the gimbal according to the speed of the mouse.

11. The method according to claim 10,
wherein the switching signal is a first switching signal;
the method further comprising, after receiving the first switching signal:
receiving a second switching signal; and
wherein determining the speed of the yaw-axis electric motor and the speed of the pitch-axis electric motor according to the speed of the mouse is performed after the second switching signal is received.

12. The method according to claim 11, wherein:
the first switching signal is generated in response to a right-button of the mouse being triggered; and
the second switching signal is generated in response to a left-button of the mouse being triggered.

13. A gimbal comprising:
an electric motor;
an electronic speed control (ESC) electrically connected to the electric motor; and
a processor electrically connected to the ESC and configured to be communicatively connected to a mouse, the processor being configured to:
obtain a speed of the mouse; and
control an attitude of the gimbal according to the speed of the mouse.

14. The gimbal according to claim 13, wherein the processor is further configured to:
determine a target speed of the gimbal according to the speed of the mouse; and
determine a target attitude of the gimbal according to the target speed of the gimbal.

15. The gimbal according to claim 14, wherein the processor is further configured to:
convert the speed of the mouse to the target speed of the gimbal according a pre-configured strategy.

16. The gimbal according to claim 15, wherein the processor is further configured to:
convert the speed of the mouse to the target speed of the gimbal according to a pre-configured linear mapping relationship or a pre-configured curved mapping relationship between the speed of the mouse and the target speed of the gimbal.

17. A gimbal control system comprising:
a mouse assembly including a mouse; and
a gimbal including:
an electric motor;
an electronic speed control (ESC) electrically connected to the electric motor; and
a processor electrically connected to the ESC and communicatively connected to the mouse, the processor being configured to:
obtain a speed of the mouse; and
control an attitude of the gimbal according to the speed of the mouse.

18. The gimbal control system according to claim 17, wherein the processor is further configured to:
determine a target speed of the gimbal according to the speed of the mouse; and
determine a target attitude of the gimbal according to the target speed of the gimbal.

19. The gimbal control system according to claim 18, wherein the processor is further configured to:
convert the speed of the mouse to the target speed of the gimbal according a pre-configured strategy.

20. The gimbal control system method according to claim 19, wherein the processor is further configured to:
converting the speed of the mouse to the target speed of the gimbal according to a pre-configured linear mapping relationship or a pre-configured curved mapping relationship between the speed of the mouse and the target speed of the gimbal.
